(19) United States
(12) Patent Application Publication
(10) Pub. No.: US 2013/0051714 A1
(43) Pub. Date: Feb. 28, 2013

(54) HYDRODYNAMIC BEARING ASSEMBLY AND METHOD OF MANUFACTURING THE SAME

(71) Applicants: Ha Yong Jung, Suwon (KR); Myung Hwa Choi, Suwon (KR); Sang Hyun Kwon, Suwon (KR); Hyung Kyu Kim, Daejeon (KR); Kun Kim, Suwon (KR)

(72) Inventors: Ha Yong Jung, Suwon (KR); Myung Hwa Choi, Suwon (KR); Sang Hyun Kwon, Suwon (KR); Hyung Kyu Kim, Daejeon (KR); Kun Kim, Suwon (KR)

(73) Assignee: SAMSUNG ELECTRO-MECHANICS CO., LTD.

(21) Appl. No.: 13/333,589

(22) Filed: Dec. 21, 2011

(30) Foreign Application Priority Data
Aug. 23, 2011 (KR) 10-2011-0084111

(51) Int. Cl. F16C 32/06; F16C 33/00

(52) U.S. Cl. 384/100; 29/898.02

(57) ABSTRACT

There are provided a hydrodynamic bearing assembly and a method of manufacturing the same. The hydrodynamic bearing assembly includes: a lubricating oil filled so as to form a liquid-vapor interface between stationary members and rotating members; and a lipophilic coating formed on the liquid-vapor interface of the lubricating oil so as to prevent lubricating oil leakage. Therefore, the lipophilic coating is formed on the interface of the lubricating oil and an oil repellent material is formed on a surface of at least one of the stationary members and the rotating members, whereby the scattering and the leakage of the lubricating oil may be effectively prevented.

### CROSS-REFERENCE TO RELATED APPLICATIONS

This application claims the priority of Korean Patent Application No. 10-2011-0084111 filed on Aug. 23, 2011, in the Korean Intellectual Property Office, the disclosure of which is incorporated herein by reference.

### BACKGROUND OF THE INVENTION

1. Field of the Invention

The present invention relates to a hydrodynamic bearing assembly for minimizing lubricating oil scattering, and a method of manufacturing the same.

2. Description of the Related Art

A hard disk drive (HDD), an information storage device, reads data stored on a disk or writes data to a disk using a read/write head.

The hard disk drive requires a disk driving device capable of driving the disk. As the disk driving device, a small-sized spindle motor is used.

This small-sized spindle motor commonly uses a hydrodynamic bearing assembly. A lubricating fluid is interposed between a shaft, a rotating member of the hydrodynamic bearing assembly, and a sleeve, a stationary member thereof, such that the shaft is supported by fluid pressure generated in the lubricating fluid.

Further, in the spindle motor including the hydrodynamic bearing assembly, a fluid sealing part is configured using surface tension of the fluid and a capillary phenomenon. In the sealing part, stability is an important factor.

However, when an external impact is applied to the spindle motor in a state in which the spindle motor has been driven and stopped, a phenomenon in which the lubricating fluid forming a lubricating fluid interface is leaked to the outside occurs, to thereby cause loss of the lubricating fluid, thereby deteriorating driving stability of the spindle motor.

Therefore, research into a technology for preventing the leakage of lubricating fluid when an external impact is applied to a spindle motor and allowing leaked lubricating fluid to be re-introduced to the spindle motor in the direction of a lubricating fluid interface even in a case in which the lubricating fluid is leaked to thereby improve stability of motor driving has been urgently demanded.

### SUMMARY OF THE INVENTION

An aspect of the present invention provides a hydrodynamic bearing assembly for minimizing lubricating oil scattering.

According to an aspect of the present invention, there is provided a hydrodynamic bearing assembly including: a lubricating oil filled so as to form a liquid-vapor interface between stationary members and rotating members; and a lipophilic coating formed on the liquid-vapor interface of the lubricating oil so as to prevent lubricating oil leakage.

The hydrodynamic bearing assembly may further include an oil repellent material formed on a surface of at least one of the stationary members and the rotating members.

The liquid-vapor interface of the lubricating oil may be an interface on which the lubricating oil and at least one of the stationary members and the rotating members contact each other.

The lipophilic coating may be made of at least one selected from a group consisting of parylene, vinyl acetal, vinyl ester, and a fluorocarbon, and a contact angle between the lipophilic coating and the lubricating oil may be 10 degrees or less.

The oil repellent material may be a fluorine-based material, and a contact angle between the oil repellent material and the lubricating oil may be 70 degrees or more.

According to another aspect of the present invention, there is provided a hydrodynamic bearing assembly including: an oil sealing part formed between stationary members and rotating members; a lubricating oil filled so as to form a liquid-vapor interface in the oil sealing part; a lipophilic coating disposed to prevent lubricating oil leakage from the oil sealing part and formed on the liquid-vapor interface of the lubricating oil; and an oil repellent material disposed to prevent the lubricating oil leakage from the oil sealing part and formed on a surface of at least one of the stationary members and the rotating members.

The liquid-vapor interface of the lubricating oil may be an interface on which the lubricating oil and at least one of the stationary members and the rotating members contact each other.

The lipophilic coating may be made of at least one selected from a group consisting of parylene, vinyl acetal, vinyl ester, and a fluorocarbon, and a contact angle between the lipophilic coating and the lubricating oil may be 10 degrees or less.

The oil repellent material may be a fluorine-based material, and a contact angle between the oil repellent material and the lubricating oil may be 70 degrees or more.

According to another aspect of the present invention, there is provided a method of manufacturing a hydrodynamic bearing assembly, the method including: preparing fixed members and rotating members having an oil sealing part formed therebetween; forming a lipophilic coating so as to prevent oil leakage from the oil sealing part; and filling the oil sealing part with a lubricating oil so as to form a liquid-vapor interface in the oil sealing part, wherein the lipophilic coating is formed on the liquid-vapor interface of the lubricating oil.

The method may further include forming an oil repellent material on a surface of at least one of the stationary members and the rotating members so as to prevent the oil leakage from the oil sealing part.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view of a motor including a hydrodynamic bearing assembly according to a first embodiment of the present invention;

FIG. 2 is a schematic cross-sectional view of a motor including a hydrodynamic bearing assembly according to a second embodiment of the present invention;

FIG. 3 is a schematic cross-sectional view of a motor including a hydrodynamic bearing assembly according to a third embodiment of the present invention;

FIG. 4 is a schematic cross-sectional view of a motor including a hydrodynamic bearing assembly according to a fourth embodiment of the present invention;

FIG. 5 is a schematic cross-sectional view of a motor including a hydrodynamic bearing assembly according to a fifth embodiment of the present invention;

FIG. 6 is a schematic cross-sectional view of a motor including a hydrodynamic bearing assembly according to a sixth embodiment of the present invention;

FIG. 7 is a scanning electron microscope (SEM) photograph showing an oil contact angle after a formation of an oil repellent material according to an embodiment of the present invention; and

FIG. 8 is a SEM photograph showing an oil contact angle after a formation of a lipophilic coating material according to an embodiment of the present invention.

### DETAILED DESCRIPTION OF THE PREFERRED EMBODIMENT

Embodiments of the present invention may be modified in many different forms and the scope of the invention should not be seen as being limited to the embodiments set forth herein.

Rather, these embodiments are provided so that this disclosure will be thorough and complete, and will fully convey the concept of the invention to those skilled in the art. In the drawings, the shapes and dimensions of elements may be exaggerated for clarity, and the same reference numerals will be used throughout to designate the same or like components.

Embodiments of the present invention will now be described in detail with reference to the accompanying drawings.

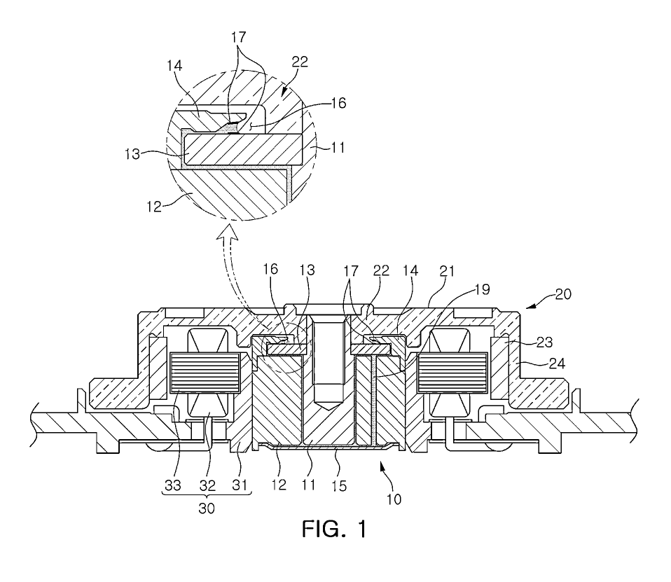

FIG. 1 is a schematic cross-sectional view of a motor including a hydrodynamic bearing assembly according to a first embodiment of the present invention.

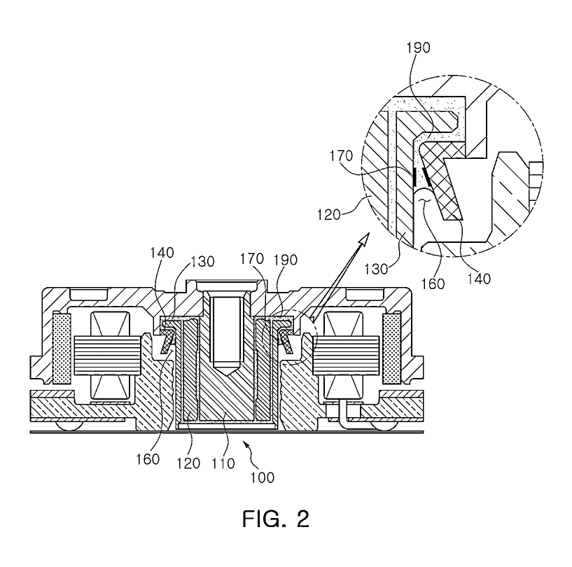

FIG. 2 is a schematic cross-sectional view of a motor including a hydrodynamic bearing assembly according to a second embodiment of the present invention.

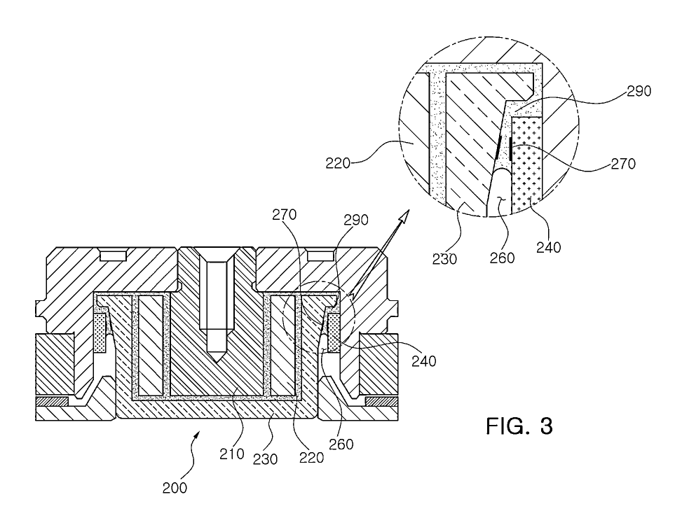

FIG. 3 is a schematic cross-sectional view of a motor including a hydrodynamic bearing assembly according to a third embodiment of the present invention.

Referring to FIG. 1, a hydrodynamic bearing assembly 10 according to the first embodiment of the present invention may include a lubricating oil 19 filled so as to form a liquid-vapor interface between stationary members 12 and 14 and rotating members 11, 13, and 22; and a lipophilic coating 17 formed on the liquid-vapor interface of the lubricating oil 19 so as to prevent leakage of the lubricating oil 19.

Hereinafter, the above configuration will be described in detail.

The stationary members may be a sleeve 12 and a cap member 14, and the rotating members may be a shaft 11, a thrust plate 13, and a hub 22.

An oil sealing part 16 may be formed between the stationary members 12 and 14 and the rotating members 11, 13, and 22, particularly, between the sleeve 12, the thrust plate 13, and the cap member 14.

The cap member 14 is a member press-fitted into an upper portion of the thrust plate 13 to thereby allow the lubricating oil 19 to be sealed between the cap member 14 and the thrust plate 13, and including a circumferential groove formed in an outer diameter direction so as to be press-fitted into the thrust plate 13 and the sleeve 12.

The cap member 14 may include a protrusion part formed at a lower surface thereof for the sealing of the lubricating oil 19, and the sealing of the lubricating oil 19 may use a capillary phenomenon and surface tension of the lubricating oil in order to prevent the lubricating oil 19 from being leaked to the outside at the time of the driving of the motor.

The hydrodynamic bearing assembly 10 according to the embodiment of the present invention may include the lubricating oil 19 filled so as to form the liquid-vapor interface between the stationary members 12 and 14 and the rotating members 11, 13, and 22; and the lipophilic coating 17 formed on the liquid-vapor interface of the lubricating oil 19 so as to prevent the leakage of the lubricating oil 19.

The liquid-vapor interface of the lubricating oil 19 is not particularly limited, but may be, for example, an interface at which the lubricating oil 19 and at least one of the stationary members 12 and 14 and the rotating members 11, 13, and 22 contact each other.

In addition, a material for the lipophilic coating 17 (‘a lipophilic coating material’) is not particularly limited as long as it has lipophilicity, but may be at least one selected from a group consisting of, for example, parylene, vinyl acetal, vinyl ester, and a fluorocarbon.

The material for the lipophilic coating 17, which is generally a material having a small contact angle between a liquid surface and a solid surface, may refer to a material allowing liquid droplets to be easily spread on the solid surface.

That is, according to the embodiment of the present invention, a contact angle between the lipophilic coating 17 and the lubricating oil may be 10 degrees or less.

According to the embodiment of the present invention, the contact angle between the lipophilic coating 17 and the lubricating oil is 10 degrees or less and thus, lipophilicity is significantly large, such that scattering of the lubricating oil 19 to the outside of the hydrodynamic bearing assembly may be effectively prevented and the lubricating oil 19 may be preserved in the inside thereof.

Therefore, the hydrodynamic bearing assembly 10 according to the embodiment of the present invention includes the lipophilic coating 17 having the contact angle of 10 degrees or less with respect to the lubricating oil, whereby the scattering of the lubricating oil 19 may be minimized.

Among materials for the lipophilic coating 17, parylene may show a surface contact angle of 5 degrees or less, with respect to a fluid dynamic bearing (FEB) oil used in the hydrodynamic bearing assembly, and excellent lipophilicity.

The parylene may be a polymer material, represented by parylene N, C, and D as follows.

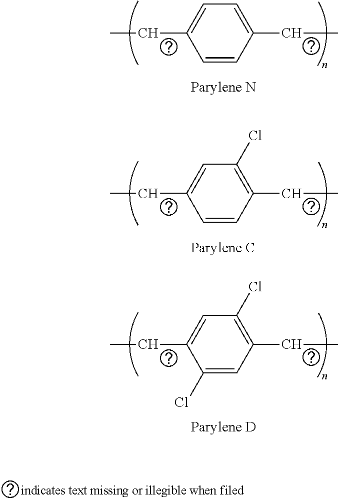

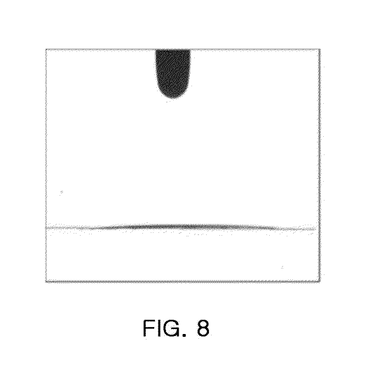

FIG. 8 is a scanning electron microscope (SEM) photograph showing an oil contact angle after a formation of a lipophilic coating material, in particular, parylene, according to an embodiment of the present invention.

Referring to FIG. 8, it may be appreciated that the oil contact angle after a formation of the parylene is 3.5 degrees, which demonstrates that lipophilicity is excellent.

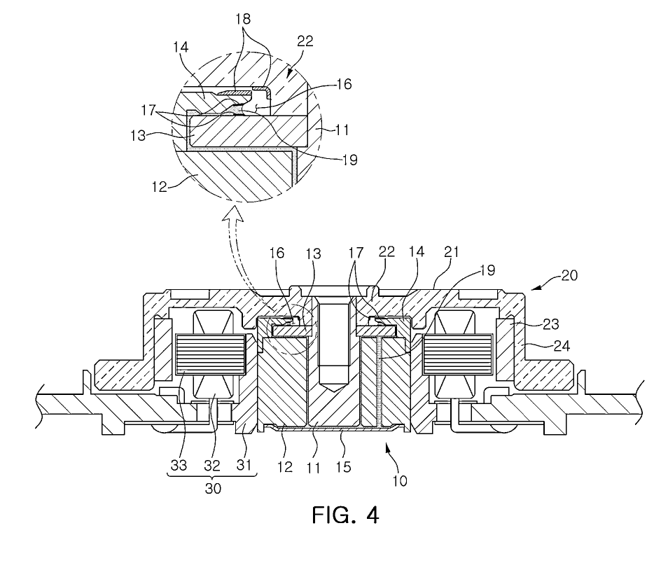

FIG. 4 is a schematic cross-sectional view of a motor including a hydrodynamic bearing assembly according to a fourth embodiment of the present invention.

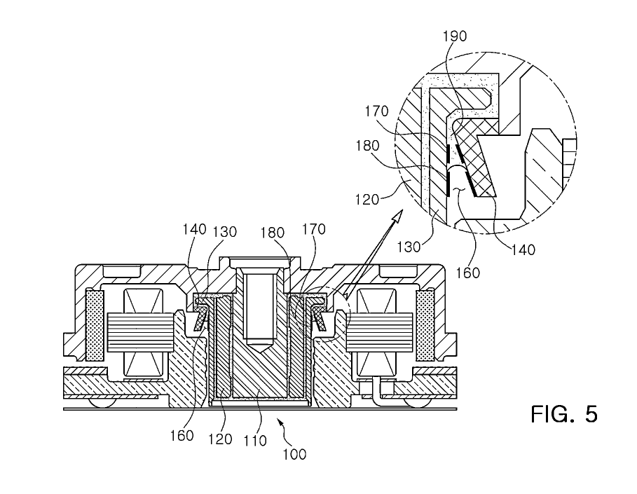

FIG. 5 is a schematic cross-sectional view of a motor including a hydrodynamic bearing assembly according to a fifth embodiment of the present invention.

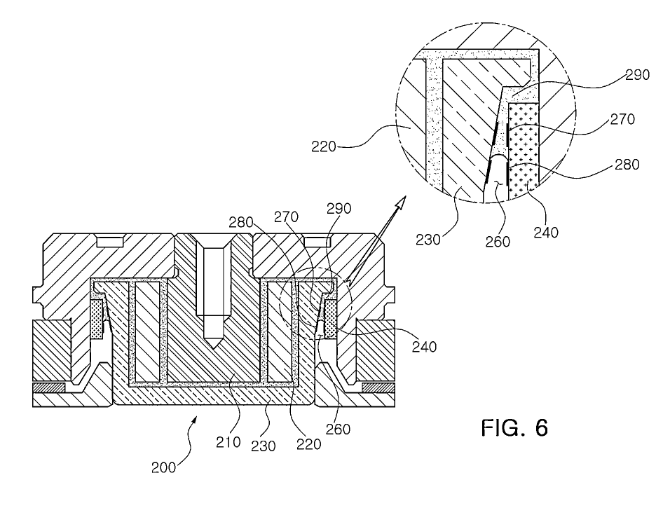

FIG. 6 is a schematic cross-sectional view of a motor including a hydrodynamic bearing assembly according to a sixth embodiment of the present invention.

Referring to FIG. 4, the hydrodynamic bearing assembly 10 according to the fourth embodiment of the present invention may further include an oil repellent material 18 formed on a surface of at least one of the stationary members 12 and 14 and the rotating members 11, 13, and 22.

The oil repellent material 18, a material having a large contact angle between a liquid surface and a solid surface, may refer to a material allowing liquid droplets not able to be easily spread on the solid surface while allowing for the formation of liquid droplets having a predetermined angle with respect to the solid surface.

In this case, adhesion between the corresponding liquid and the solid surface may be deteriorated. A material having such properties may be defined as the oil repellent material.

According to the embodiment of the present invention, the oil repellent material 18 is not particularly limited as long as it has oil repellency due to a large contact angle with respect to oil, but may be, for example, a fluorine-based material.

Particularly, a contact angle between the oil repellent material 18 and the oil may be 70 degrees or more.

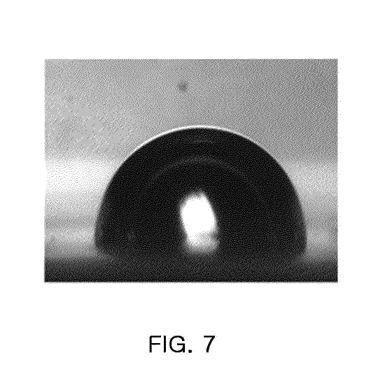

FIG. 7 is a scanning electron microscope (SEM) photograph showing an oil contact angle after a formation of an oil repellent material according to an embodiment of the present invention.

Referring to FIG. 7, it may be appreciated that the oil contact angle after a formation of the fluorine is 84 degrees, which demonstrates that oil repellency is excellent.

The hydrodynamic bearing assembly 10 according to the embodiment of the present invention further includes the oil repellent material 18 formed on the surface of at least one of the stationary members 12 and 14 and the rotating members 11, 13, and 22, the oil repellent material 18 having the contact angle of 70 degrees or more with respect to the lubricating oil, whereby preventing the scattering of the lubricating oil 19 may be more effectively improved.

That is, according to the fourth embodiment of the present invention, the lipophilic coating 17 may effectively prevent the lubricating oil 19 from being scattered to the outside of the hydrodynamic bearing assembly and allow the lubricating oil 19 to be effectively maintained in the inside thereof, and the oil repellent material 18 may allow the lubricating oil 19 to be directed toward the inside without being leaked to the outside, whereby preventing the scattering of the lubricating oil 19 may be maximized.

Meanwhile, the hydrodynamic bearing assembly 10 according to the embodiment of the present invention may include the shaft 11, the sleeve 12, the thrust plate 13, the cap member 14, and the oil sealing part 16.

The sleeve 12 may support the shaft 11 in such a manner that an upper end of the shaft 11 protrudes upwardly in an axial direction, and may be formed by forging copper (Cu) or aluminum (Al) or sintering copper-iron (Cu—Fe) based alloy powders or SUS based powders.

In this configuration, the shaft 11 is inserted into a shaft hole of the sleeve 12, such that a micro clearance may be formed between the shaft 11 and the shaft hole of the sleeve 12. A lubricating fluid fills the micro clearance, and the rotation of the rotor 20 may be more smoothly supported by a radial dynamic groove (not shown) formed in at least one of an outer diameter of the shaft 11 and an inner diameter of the sleeve 12.

The radial dynamic groove is formed in an inside of the sleeve 12, which is an inner portion of the shaft hole of the sleeve 12, and generates pressure such that the shaft 11 is biased toward one side at the time of rotation thereof.

However, the radial dynamic groove is not limited to being formed in the inside of the sleeve 12 as described above but may also be formed in an outer diameter portion of the shaft 11. In addition, the number of radial dynamic grooves is not limited.

Here, the sleeve 12 may include a cover plate 15 coupled thereto at a lower portion thereof, while having a clearance therebetween, the clearance accommodating the lubricating fluid therein.

The cover plate 15 may accommodate the lubricating fluid in the clearance between the cover plate 15 and the sleeve 12 to thereby serve as a bearing supporting a lower surface of the shaft 11.

The thrust plate 13 is disposed upwardly of the sleeve 120 in the axial direction and includes a hole formed at the center thereof. The shaft 11 may be inserted into this hole.

In this configuration, the thrust plate 13 may be separately manufactured and then coupled to the shaft 11. However, the thrust plate 13 may be integrally formed with the shaft 11 at the time of manufacturing thereof and may rotate together with the shaft 11 at the time of the rotation of the shaft 11.

In addition, the thrust plate 13 may include a thrust dynamic groove formed in an upper surface thereof, the thrust dynamic groove providing thrust dynamic pressure to the shaft 11.

The thrust dynamic groove is not limited to being formed in the upper surface of the thrust plate 13 as described above, but may also be formed in an upper surface of the sleeve 12 corresponding to a lower surface of the thrust plate 13.

Stator 30 may include a coil 32, a plurality of cores 33, and a base member 31.

In other words, the stator 30 may be a stationary structure including the coil 32 generating electromagnetic force having a predetermined magnitude at the time of the application of power thereto and the plurality of cores 33 having the coil 32 wound therearound.

The plurality of cores 33 may be fixedly disposed on an upper portion of a base member 31 on which a printed circuit board (not shown) having circuit patterns printed thereon is provided. A plurality of coil holes having a predetermined size are formed in an upper surface of the base member 31 corresponding to the winding coil 32 in such a manner that they penetrate through the base member 31 so as to expose the winding coil 32 downwardly. The winding coil 32 may be electrically connected to the printed circuit board (not shown) in order to supply external power.

An outer peripheral surface of the sleeve 12 may be press-fitted into the base member 31 to be fixed thereto, and the plurality of cores 33 having the coil 32 wound therearound may be inserted into the base member 31. In addition, the base member 31 may be assembled with the sleeve 12 by applying an adhesive to an inner surface of the base member 31 or an outer surface of the sleeve 12.

The rotor 20, a rotational structure provided to be rotatable with respect to the stator 30, may include a rotor case 21 having an annular ring shaped magnet 23 provided on an outer peripheral surface thereof, the annular ring shaped magnet 23 corresponding to the cores 33 while having a predetermined interval therefrom.

In addition, as the magnet 23, a permanent magnet generating magnetic force having a predetermined strength by alternately magnetizing a north (N) pole and a south (S) pole thereof in a circumferential direction is used.

Here, the rotor case 21 may include a hub base 22 press-fitted into the upper end of the shaft 11 to thereby be fixed thereto and a magnet support part 24 extended from the hub base 22 in the outer diameter direction and bent downwardly in the axial direction to thereby support the magnet 23.

Motors including hydrodynamic bearing assemblies 100 and 200 according to the second and third embodiments of the present invention are shown in FIGS. 2 and 3, respectively.

The hydrodynamic bearing assemblies 100 and 200 according to the second and third embodiment of the present invention may include lubricating oils 190 and 290 filled so as to form liquid-vapor interfaces between stationary members 120, 220, 140, and 240 and rotating members 110, 210, 130, and 230; and lipophilic coatings 170 and 270 formed on the liquid-vapor interfaces of the lubricating oils 190 and 290 so as to prevent the leakage of the lubricating oils 190 and 290.

Motors including hydrodynamic bearing assemblies 100 and 200 according to fifth and sixth embodiments of the present invention are shown in FIGS. 5 and 6, respectively.

The hydrodynamic bearing assemblies 100 and 200 may further include oil repellent materials 180 and 280, each formed on a surface of at least one of stationary members 120, 220, 140, and 240 and rotating members 110, 210, 130, and 230.

Features other than the above-mentioned feature are the same as those of the hydrodynamic bearing assembly 10 according to the first and fourth embodiment of the present invention described above. Therefore, a description thereof will be omitted.

A hydrodynamic bearing assembly according to another embodiment of the present invention may include an oil sealing part formed between stationary members and rotating members; a lubricating oil filled so as to form a liquid-vapor interface in the oil sealing part; a lipophilic coating disposed to prevent a leakage of the lubricating oil from the oil sealing part and formed on the liquid-vapor interface of the lubricating oil; and an oil repellent material disposed to prevent the leakage of the lubricating oil from the oil sealing part and formed on a surface of at least one of the stationary members and the rotating members.

The hydrodynamic bearing assembly according to another embodiment of the present invention described above may correspond to the hydrodynamic bearing assemblies according to the fourth to sixth embodiments of the present invention described above.

More specifically, the hydrodynamic bearing assembly 10 according to the fourth embodiment of the present invention may include the oil sealing part 16 formed between the stationary members 12 and 14 and the rotating members 11, 13, and 22; the lubricating oil 19 filled so as to form a liquid-vapor interface in the oil sealing part 16; the lipophilic coating 17 disposed to prevent a leakage of the lubricating oil from the oil sealing part 16 and formed on the liquid-vapor interface of the lubricating oil 19; and the oil repellent material 18 disposed to prevent the leakage of the lubricating oil from the oil sealing part 16 and formed on a surface of at least one of the stationary members 12 and 14 and the rotating members 11, 13, and 22.

In addition, the hydrodynamic bearing assemblies 100 and 200 according to the fifth and sixth embodiments of the present invention may include oil sealing parts 160 and 260 formed between the stationary members 120, 220, 140, and 240 and the rotating members 110, 210, 130, and 230; the lubricating oils 190 and 290 filled so as to form liquid-vapor interfaces in the oil sealing parts 160 and 260; the lipophilic coatings 170 and 270 disposed to prevent leakage of the lubricating oils from the oil sealing parts 160 and 260 and formed on the liquid-vapor interfaces of the lubricating oils 190 and 290; and the oil repellent materials 180 and 280 disposed to prevent the leakage of the lubricating oils from the oil sealing parts 160 and 260 and each formed on a surface of at least one of the stationary members 120, 220, 140, and 240 and the rotating members 110, 210, 130, and 230.

According to the fourth to sixth embodiments of the present invention, the lipophilic coating effectively prevents the lubricating oil from being scattered to the outside of the hydrodynamic bearing assembly and allows the lubricating oil to be effectively maintained in the inside thereof, and the oil repellent material allows the lubricating oil to be directed toward the inside without being leaked to the outside, whereby preventing the scattering of the lubricating oil may be maximized.

Since a detailed description for the hydrodynamic bearing assembly according to the fourth to sixth embodiments of the present invention are the same as the above-mentioned description, it will be omitted.

Meanwhile, a method of manufacturing the hydrodynamic bearing assembly 10 according to another embodiment of the present invention may include: preparing stationary members and rotating members having an oil sealing part formed therebetween; forming a lipophilic coating so as to prevent leakage of lubricating oil from the oil sealing part; and filling the oil sealing part with lubricating oil so as to form a liquid-vapor interface in the oil sealing part, the lipophilic coating being formed on the liquid-vapor interface of the lubricating oil.

In addition, the method of manufacturing the hydrodynamic bearing assembly may further include forming an oil repellent material on a surface of at least one of the stationary members and the rotating members so as to prevent the leakage of the lubricating oil from the oil sealing part.

The method of manufacturing the hydrodynamic bearing assembly 10 according to another embodiment of the present invention may be in accordance with a general method of manufacturing a hydrodynamic bearing assembly except for the above-mentioned feature.

Hereinafter, features regarding the method of manufacturing the hydrodynamic bearing assembly 10 according to another embodiment of the present invention will be described in detail. However, a description overlapped with the feature of the hydrodynamic bearing assembly described above and a general manufacturing process will be omitted.

In the method of manufacturing a hydrodynamic bearing assembly 10 according to the embodiment of the present invention, stationary members and rotating members having an oil sealing part formed therebetween may be first prepared.

The stationary members and the rotating members are not particularly limited. Examples of the stationary members and the rotating members have been described above.

Then, a lipophilic coating may be formed so as to prevent an oil leakage from the oil sealing part, the lipophilic coating being formed on a liquid-vapor interface of a lubricating oil. Next, the lubricating oil may be filled so as to form the liquid-vapor interface in the oil sealing part.

In addition, an oil repellent material may be further formed on a surface of at least one of the stationary members and the rotating members in order to maximize an effect of preventing lubricating oil scattering.

The hydrodynamic bearing assembly according to the embodiment of the present invention includes the lipophilic coating effectively preventing the lubricating oil from being scattered to the outside of the hydrodynamic bearing assembly and allowing the lubricating oil to be effectively maintained in the inside thereof and the oil repellent material allowing the lubricating oil to be directed toward the inside without being leaked to the outside, whereby an effect of preventing lubricating oil scattering may be maximized.

As set forth above, according to the embodiments of the present invention, the lipophilic coating is formed on the liquid-vapor interface of the lubricating oil and the oil repellent material is formed on a surface of at least one of the stationary members and the rotating members, whereby the scattering and the leakage of the lubricating oil could be effectively prevented.

While the present invention has been shown and described in connection with the embodiments, it will be apparent to those skilled in the art that modifications and variations can be made without departing from the spirit and scope of the invention as defined by the appended claims.

What is claimed is:

1. A hydrodynamic bearing assembly comprising:
a lubricating oil filled so as to form a liquid-vapor interface between stationary members and rotating members; and
a lipophilic coating formed on the liquid-vapor interface of the lubricating oil so as to prevent lubricating oil leakage.

2. The hydrodynamic bearing assembly of claim 1, further comprising an oil repellent material formed on a surface of at least one of the stationary members and the rotating members.

3. The hydrodynamic bearing assembly of claim 1, wherein the liquid-vapor interface of the lubricating oil is an interface on which the lubricating oil and at least one of the stationary members and the rotating members contact each other.

4. The hydrodynamic bearing assembly of claim 1, wherein the lipophilic coating is made of at least one selected from a group consisting of parylene, vinyl acetal, vinyl ester, and a fluorocarbon.

5. The hydrodynamic bearing assembly of claim 1, wherein a contact angle between the lipophilic coating and the lubricating oil is 10 degrees or less.

6. The hydrodynamic bearing assembly of claim 2, wherein the oil repellent material is a fluorine-based material.

7. The hydrodynamic bearing assembly of claim 2, wherein a contact angle between the oil repellent material and the lubricating oil is 70 degrees or more.

8. A hydrodynamic bearing assembly comprising:
an oil sealing part formed between stationary members and rotating members;
a lubricating oil filled so as to form a liquid-vapor interface in the oil sealing part;
a lipophilic coating disposed to prevent lubricating oil leakage from the oil sealing part and formed on the liquid-vapor interface of the lubricating oil; and
an oil repellent material disposed to prevent the lubricating oil leakage from the oil sealing part and formed on a surface of at least one of the stationary members and the rotating members.

9. The hydrodynamic bearing assembly of claim 8, wherein the liquid-vapor interface of the lubricating oil is an interface on which the lubricating oil and at least one of the stationary members and the rotating members contact each other.

10. The hydrodynamic bearing assembly of claim 8, wherein the lipophilic coating is made of at least one selected from a group consisting of parylene, vinyl acetal, vinyl ester, and a fluorocarbon.

11. The hydrodynamic bearing assembly of claim 8, wherein a contact angle between the lipophilic coating and the lubricating oil is 10 degrees or less.

12. The hydrodynamic bearing assembly of claim 8, wherein the oil repellent material is a fluorine-based material.

13. The hydrodynamic bearing assembly of claim 8, wherein a contact angle between the oil repellent material and the lubricating oil is 70 degrees or more.

14. A method of manufacturing a hydrodynamic bearing assembly, the method comprising:
preparing fixed members and rotating members having an oil sealing part formed therebetween;
forming a lipophilic coating so as to prevent oil leakage from the oil sealing part; and
filling the oil sealing part with a lubricating oil so as to form a liquid-vapor interface in the oil sealing part,
wherein the lipophilic coating is formed on the liquid-vapor interface of the lubricating oil.
